(19) United States
(12) Patent Application Publication
(10) Pub. No.: US 2008/0112125 A1
(43) Pub. Date: May 15, 2008

(54) Portable hard drive with axis specific shock absorption

(75) Inventors: Robert C. Martin, St. Paul, MN (US); Peter A. Ridl, Oakdale, MN (US); Leo W. Spychalla, Cottage Grove, MN (US)

Correspondence Address: Attn: Eric D. Levinson;Imation Corp., Legal Affairs, P.O. Box 64898, St. Paul, MN, 55164-0898, US

(73) Assignee: Imation Corp.

(21) Appl. No.: 11/595,288

(22) Filed: Nov. 9, 2006

(51) Int. Cl. G06F 1/16

(52) U.S. Cl. 361/685

(57) ABSTRACT

A portable hard disk drive includes a housing, a hard drive assembly disposed within the housing, and isolation material coupled to the hard drive assembly. The housing forms an enclosure defined by opposing first and second ends, opposing sides extending between the opposing first and second ends, and a top surface opposite a bottom surface. The hard drive assembly is disposed within the enclosure. The isolation material displaces the hard drive assembly from the opposing first and second ends by an end sway space and displaces the hard drive assembly from each of the opposing sides by a side sway space. In this regard, the end sway space is greater than the side sway space.

### BACKGROUND

Mass storage devices, such as hard disk drives and optical disk drives, have become popular data storage components that are useful in storing data, and backing up stored data, in computer systems. For example, mass storage devices have become the preferred tool for backing up stored data and/or secure data across nearly all sectors of business and industry.

Recently, mass storage devices have been developed that are mobile, and thus permit modular and removable data backup of computer systems. These so-called portable hard disk drives include removable hard drives and external hard drives. Removable hard drives include a mounting component (dock) that maintains contact with the host operating system even when the removable hard drive is removed. Since this component (dock) is enumerated by the host operating system, a removable hard drive can be mounted. An external hard drive is portable but must be re-enumerated and re-mounted each time it is connected to the operating system.

In any of its forms, a portable hard drive includes a cartridge that houses a hard drive assembly and some form of connector/bus that enables electrical connection between the hard drive assembly and a computer system. Portable hard disk drives are particularly useful when dedicated to the storage of selected, secure data. For example, for security and/or data integrity reasons, a user might prefer to back up certain secure data that is best stored separately (i.e., segregated) from continuous operative association with any one computer system. In this regard, portable hard disk drives are ideally suited for storing data prior to transportation of the removable drive to a secure, off-site storage facility.

In general, portable hard disk drives are highly transportable and easily moved between computer systems and facilities. Typically, the portable hard disk drive is employed to store selected data, after which the portable hard disk drive is transported to an off-site facility for safekeeping. Occasionally, the portable hard disk drive is retrieved from the storage facility and employed to back up additional data stored on the same (or a different) computer system. Thereafter, the portable hard disk drive is once again returned to the storage facility and maintained as a secure data backup of the information downloaded/saved from the computer system.

The movement of the portable hard disk drive between the storage facility and the computer system(s) presents certain risks of data loss during handling and transportation. For example, damage to the portable hard disk drive due to shocks or vibration caused by dropping or mishandling of the portable drive can render the saved data vulnerable to loss. In this regard, a variety of failure mechanisms is associated with portable hard disk drives. It is desirable to minimize or eliminate these failure mechanisms to ensure the integrity of the stored data.

For example, dropping a portable hard disk drive flat-side down (i.e., onto a face of the cartridge) is associated with a failure mechanism that results in the shattering or permanently damaging one or more hard disks within the disk drive assembly. Dropping the portable hard disk drive on one of its sides is associated with a failure mechanism that can result in the temporary or permanent loss of one or more tracks of data stored on one or more of the disks of the hard drive assembly. Alternatively, dropping the portable hard disk drive on its leading end (or nose) excites a failure mechanism associated with a head of the hard drive assembly becoming “unparked” and crashing into a surface of the disk(s). This so-called “head crash” damages the disk to the extent that one or more data files stored on the disk can be lost, or irretrievable.

Portable hard disk drives can be protected to some extent against the vibration and shock associated with dropping the drive. For example, some portable hard disk drives include a mechanical mechanism that locks the read/write head during transportation. Other portable hard disk drives include round pads of vibration-absorbing material disposed between the hard drive assembly and the cartridge that lessens the shock imparted to the hard drive assembly. However, as the use of portable hard disk drives inevitably increases due to their popularity, manufacturers and users both recognize that it is highly desirable to further improve the shock and vibration resistance of these drives.

### SUMMARY

One aspect of the present invention provides a portable hard disk drive. The portable hard disk drive includes a housing, a hard drive assembly disposed within the housing, and isolation material coupled to the hard drive assembly. The housing forms an enclosure defined by opposing first and second ends, opposing sides extending between the opposing first and second ends, and a top surface opposite a bottom surface. The hard drive assembly is disposed within the enclosure. The isolation material displaces the hard drive assembly from the opposing first and second ends by an end sway space and displaces the hard drive assembly from each of the opposing sides by a side sway space. In this regard, the end sway space is greater than the side sway space.

Another aspect of the present invention provides a method of providing axis specific shock absorption for a portable hard disk drive. The method provides forming a housing that defines an enclosure, and disposing a hard drive assembly within the enclosure. In this regard, the enclosure defines a longitudinal space between a leading end of the hard drive assembly and a first end of the enclosure, a lateral space between a side of the hard drive assembly and a side of the enclosure, and a clearance space between a major surface of the hard drive assembly and an interior surface of the enclosure. The method additionally provides distributing shock absorbing material unequally between the longitudinal, lateral, and clearance spaces.

Yet another aspect of the present invention provides a cartridge configured to portably maintain a hard drive assembly. The cartridge includes a housing defining an enclosure and shock isolation material disposed within the enclosure. The enclosure includes opposing first and second ends, opposing sides extending between the opposing first and second ends, and a top surface opposite a bottom surface. The shock isolation material includes a first segment coupleable to a first portion of the hard drive assembly to extend between the opposing first and second ends of the enclosure, and a second segment coupleable to a second portion of the hard drive assembly to extend between the opposing first and second ends of the enclosure. In this regard, when the first and second segments of the shock isolation material are coupled to the hard drive assembly, the hard drive assembly is spaced a distance from the ends of the enclosure that is at least a factor of two greater than a distance that the hard drive assembly is spaced from the sides of the enclosure.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 illustrates a perspective exploded view of a portable hard disk drive according to one embodiment of the present invention;

FIG. 2 illustrates a top view of a housing section of a cartridge of the portable hard disk drive shown in FIG. 1;

FIG. 3 illustrates a perspective view of a segment of shock isolation material insertable into the housing section shown in FIG. 2 in accordance with one embodiment of the present invention;

FIG. 4 illustrates a side view of the shock isolation material shown in FIG. 3;

FIG. 5 illustrates a lateral cross-sectional view of the shock isolation material shown in FIG. 3;

FIG. 6 illustrates a top view of a hard drive assembly enclosed in the housing section and including two segments of isolation material according to one embodiment of the present invention; and

FIG. 7 illustrates a lateral cross-sectional view of an assembled portable hard disk drive according to one embodiment of the present invention.

### DETAILED DESCRIPTION

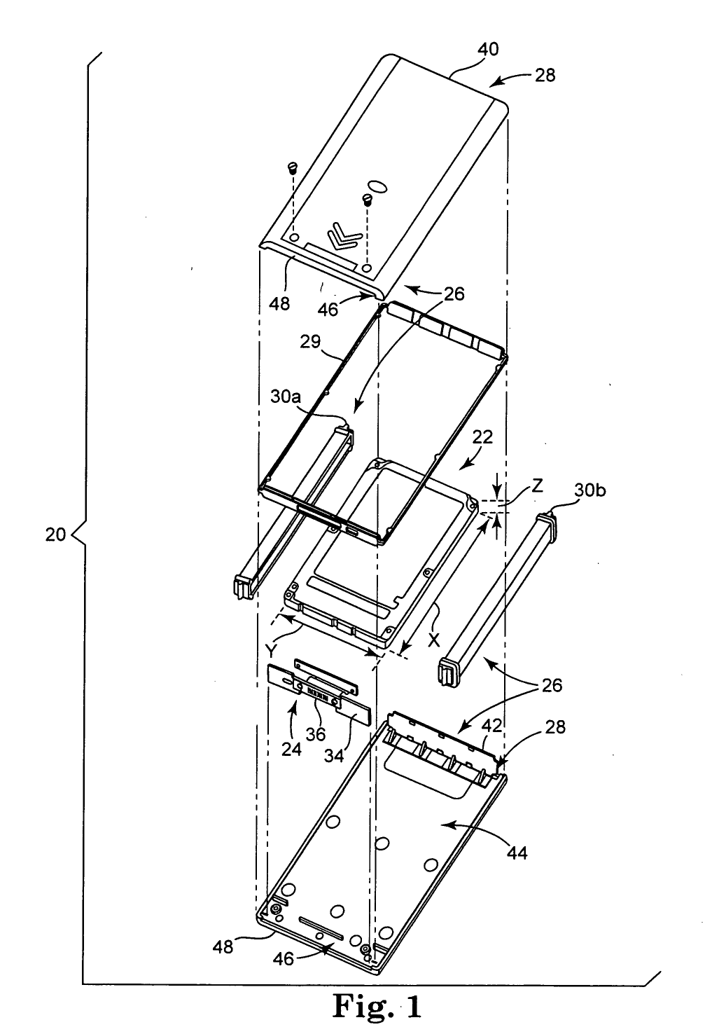

FIG. 1 illustrates an exploded perspective view of a portable hard disk drive (PHDD) 20 according to one embodiment of the present invention. In one embodiment, the PHDD 20 is a removable hard disk drive. In another embodiment, the PHDD 20 is an external disk drive. In any regard, the PHDD 20 includes a hard drive assembly 22 having an electrical connector 24, both of which are protectively maintained within a cartridge 26. The cartridge 26 includes a housing 28, a flexible gasket 29 that seals about the housing 28, and shock isolation material 30a, 30b that is configured to cushion and attenuate shock in protecting the hard drive assembly 22.

The hard drive assembly 22 is illustrated in a simplified, assembled form and includes a read/write head and one or more hard disks (not shown) within the assembly 22. In one embodiment, the hard drive assembly 22 is a known serial advanced technology attachment (SATA) 2.5 inch hard drive that is sized to fit within the housing 28. During use, the housing 28 that encloses the hard drive assembly 22 is inserted into a docking station (not shown) that is sized to fit into a standard 3.5 inch drive bay of a computer system, for example. In this manner, the hard drive assembly 22 communicates with and enables efficient and low cost backup of data from the computer system. In a preferred configuration, the hard drive assembly 22 is of a type that enables the PHDD 20 to be employed with any drag-and-drop based operating system as well as most storage management software packages offered by other independent software providers.

The hard drive assembly 22 in one embodiment is a 2.5-inch SATA hard drive that complies with the Serial ATA International Organization standards for portable drives. To this end, the hard drive assembly defines an XYZ form factor where X is about 3.94 inches, Y is about 2.75 inches, and Z is about 0.37 inches, such that the form factor of the hard drive assembly 22 complies with the standardized size for 2.5-inch SATA hard drive assemblies. Manufacturers and users of standard hard drive assemblies 22 have found it convenient to define an aspect ratio for the drive assembly that is normalized relative to the Z dimension (referenced above), such that the normalized aspect ratio of the drive assembly is (X/Z, Y/Z, Z/Z)=(11, 7, 1). One suitable hard drive assembly 22 includes a 2.5-inch SATA hard drive available from Fujitsu, Thailand, Model No. MHT2080BH, Part No. CA06500-B618. Other suitable hard drive assemblies are also acceptable.

The connector 24 includes a terminal (not shown) that is electrically coupleable to the hard drive assembly 22, and a front plate 34 having a bus 36 for connection with a computer system (not shown). In one embodiment, the connector 24 is a flexible electrical connector including a universal serial bus enterprise-class connector that is rated for up to 1,000,000 insertions/connections into/with a computer system. The connector 24 enables electrical connection between the PHDD 20 and the computer system to which the PHDD 20 is inserted (for example, via a docking station loaded into a 3.5-inch drive bay of the computer system), which enables the PHDD 20 to back up data stored on the computer system.

The cartridge 26 is sized to contain the hard drive assembly 22 and be insertable into a docking station and/or a drive bay of a computer system. To this end, the housing 28 exhibits a size of approximately 4.96×3.18×0.814 inch, although other dimensions are acceptable. Manufacturers and users of portable hard drives have found it convenient to define an aspect ratio for the housing (i.e., cartridge exterior) that is normalized relative to the thickness dimension (0.814 inch, for example), such that the normalized housing aspect ratio is (6, 4, 1).

The housing 28 is defined by a first housing section 40 and a second housing section 42. In one embodiment, the first housing section 40 forms a cover and the second housing section 42 forms a base. The first and second housing sections 40, 42, respectively, are sized to be reciprocally mated to one another on either side of the gasket 29 to form an enclosure 44 that retains the hard drive assembly 22. To this end, an access window 46 is defined at a leading end 48 of the housing 28 to accommodate the front plate 34. When assembled, the cover 40 and the base 42 mate on either side of the gasket 29, and the front plate 34 and the bus 36 are oriented adjacent to the leading end 48 to provide access to the connector 24.

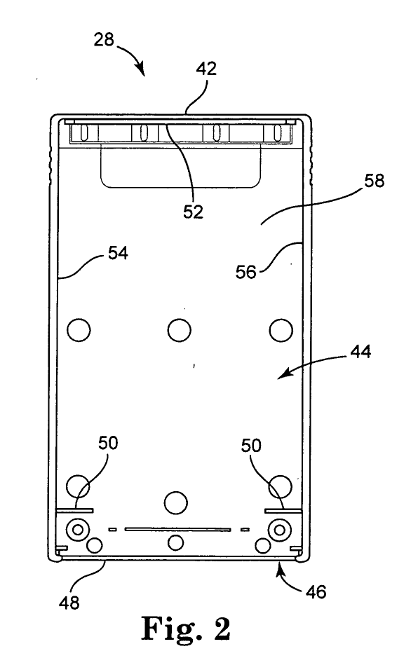

FIG. 2 illustrates a top view of the second housing section 42 of the housing 28. Since the housing 28 is defined by the reciprocally mated base 42 and the cover 40 (FIG. 1), it is to be understood that the housing sections 40, 42 are highly similar. In this regard, the second housing section 42 is described in detail with the understanding that the first housing section 40 is substantially the same.

With the above in mind, the enclosure 44 is defined by a first end 50 opposite a second end 52, opposing sides 54, 56, and a bottom surface 58. The second housing section 42 defines a portion of the access window 46 such that the first end 50 is abbreviated, and extends only part way from each of the opposing sides 54, 56. Thus, the access window 46 defines a gap formed substantially within the first end 50 of the enclosure 44. The leading end 48 of the housing is separate and offset from the first end 50 of the enclosure 44. That is to say, the housing 28, and in particular the leading 48, is elongated relative to the first end 50.

With additional reference to FIG. 1, when the segments 30a, 30b of isolation material are placed within the housing 28 to complete the cartridge 26, the isolation material 30a extends between the ends 50, 52 adjacent to the side 54, and the isolation material 30b extends between the ends 50, 52 adjacent to the side 56. In this manner, the hard drive assembly 22 is protectively retained by the isolation material 30a, 30b and offset away from the rigid surfaces of the enclosure 44 (i.e., interior surface of housing 28) and away from the front end 48 of the housing 28.

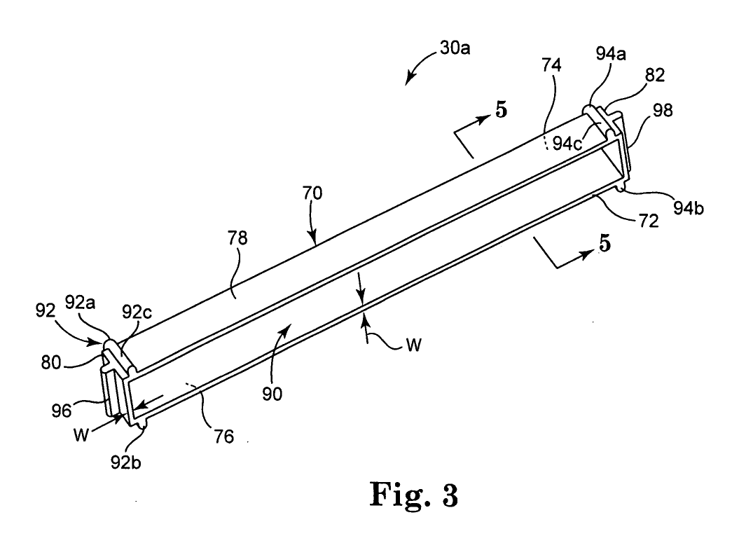

FIG. 3 illustrates a perspective view of the segment 30a of shock isolation material according to one embodiment of the present invention. The segment 30a of shock isolation material is defined by a body 70 that includes a first face 72 opposite a second face 74, and a third face 76 opposite a fourth face 78, where the faces 72-78 extend between a first end 80 opposite a second end 82. In one embodiment, the first face 72 is relieved to define a recessed cavity 90 in the body 70 that is sized to receive a side of the hard drive assembly 22 (FIG. 1). For example, in one embodiment a portion of the hard drive assembly 22 is press fit, or frictionally fit, into the recess 90 of the segment 30a of shock isolation material. In one embodiment, the recessed cavity 90 forms a uniform wall thickness W for the body 70 of about 0.035 inches.

In general, each of the second face 74, the third face 76, the fourth face 78, and the opposing ends 80, 82 are provided with at least one projecting rib, where the ribs are configured to offset the hard drive assembly 22 (FIG. 1) from the enclosure 44 of the housing 28 (FIG. 2). In one embodiment, the second face 74 includes a first rib 92a and a second rib 94a projecting from the first face 74; the third face 76 includes a first rib 92b and a second rib 94b projecting from the third face 76; the fourth face 78 includes a first rib 92c and a second rib 94c projecting from the fourth face 78; the first end 80 includes a first end rib 96 projecting from the first end 80; and the second end 82 includes a second end rib 98 projecting from the second end 82. In one embodiment, the ribs 92a, 92b, 92c define one continuous rib 92 that encircles a portion of the body 70 adjacent to the first end 80, and the ribs 94a, 94b, 94c define a second continuous rib 94 that encircles a portion of the body 70 adjacent to the second end 82. In this manner, each face of the body 70 is provided with a rib that projects from a respective one of the faces (with the exception of the first face 72 that is recessed to receive the hard drive assembly 22 of FIG. 1).

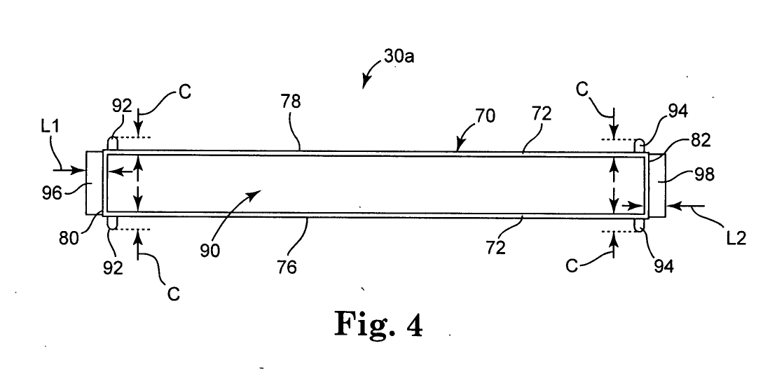

FIG. 4 illustrates a side view of the body 70 showing the recess 90 formed in the first face 72 of the segment 30a of shock isolation material. The body 70 and ribs 96, 98 are sized to extend between ends 50, 52 (FIG. 2) of enclosure 44. The ribs 92, 94 are sized to project a uniform clearance distance C off of the faces 76, 78 and away from an interior of the recess 90 to uniformly offset the hard drive assembly 22 (FIG. 1) from the surface 58 (FIG. 2) of the enclosure 44. In one embodiment, the clearance distance C is between about 0.130 inch and 0.140 inch, and preferably the clearance distance C is about 0.135 inch. The end ribs 96, 98 are sized to offset the hard drive assembly 22 from the ends 50, 52 of the enclosure 44. In one embodiment, the end rib 96 projects an end distance L1 from an interior of the recess 90, and the end rib 98 projects an end distance L2 from an interior of the recess 90, where the end distance L1 is between about 0.150 inch and 1.175 inch, and the end distance L2 is between about 0.150 inch and 1.175 inch. Axis specific shock absorption is provided for the hard drive assembly 22 by selectively sizing the end distances L1 and L2 of the end ribs 96, 98, respectively, to be greater than the clearance distance C that the ribs 92, 94 project from the recess 90.

For example, in one embodiment, the end rib 96 projects an end distance L1 of about 0.165 inch from the first end 80, and the end rib 98 projects an end distance L2 of about 0.165 inch from the second end 82, such that each end distance L1 and L2 is greater than the clearance distance C of the ribs 92, 94. In one embodiment, the distance L1 is equal to the distance L2 (collectively referred to as the end distance L), and the end distance L is about 10% greater than the clearance distance C, preferably the distance L is about 15% greater than the clearance distance C, and more preferably, the distance L is between about 15-20% greater than the clearance distance C.

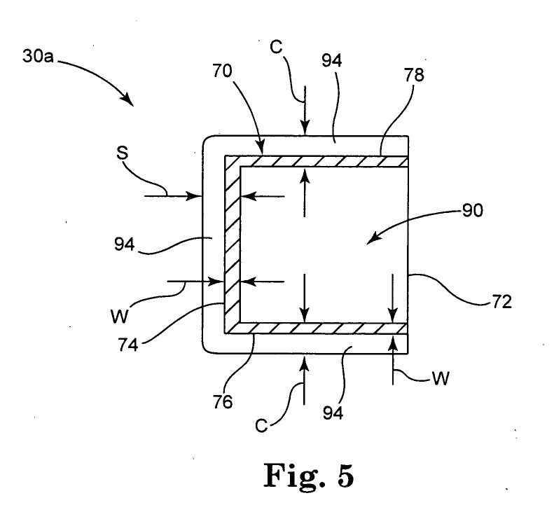

FIG. 5 illustrates a cross-sectional view of the segment 30a of shock isolation material. The rib 94 on the face 74 projects a side distance S away from an interior of the recess 90, and the rib 94 on the faces 76, 78 projects by the clearance distance C away from the recess 90. In one embodiment, the side distance S is between about 0.135 inch and 0.145 inch, and preferably the side distance S is about 0.140 inch. To this end, the side distance S is slightly larger than the clearance distance C (about 0.135 inch). In this manner, and with reference to FIG. 1, when the hard drive assembly 22 is cradled by the segment 30a of shock isolation material, the hard drive assembly 22 is maintained within the housing 28 and offset from the sides 54, 56 (FIG. 2) by the side distance S and offset from the surface 58 (FIG. 2) by the clearance distance C.

The shock absorbing material of segment 30a is configured to provide shock isolation/shock absorption for the hard drive assembly 22 (FIG. 1). In this specification, the terms shock isolation and shock absorption have the same meaning and include a shock attenuation component and a shock cushioning component. In this regard, shock isolation/shock absorption includes shock attenuation plus shock cushioning. Shock attenuation is defined to be a reduction in amplitude of a transient force, and is best understood to be a reduction in the acceleration imparted to the hard drive assembly 22 when the PHDD 20 is dropped, for example. Since force is directly proportional to acceleration, a reduction in the acceleration imparted to the hard drive assembly 22 will proportionally reduce the force that is delivered to the hard drive assembly 22. In contrast, shock cushioning is defined to be a reduction in amplitude of an impulse, where impulse is defined as a force applied over a unit time (force X time).

In one embodiment, the segment 30 of shock isolation material is molded from a plastic. In one embodiment, the segment 30 of shock isolation material is molded as a solid vinyl thermoplastic elastomer, although other plastic materials are also acceptable. In one exemplary embodiment, segments 30 of shock isolation material are molded from ISODAMP C-1002 isolation material available from E.A.R. Specialty Composites, Indianapolis, Ind., to have a nominal hardness of about 56 Shore A durometer, a 0.3% amplitude glass transition temperature of about −17 Celsius, and a max loss factor at 10 Hz of about 0.93 at 8 Celsius.

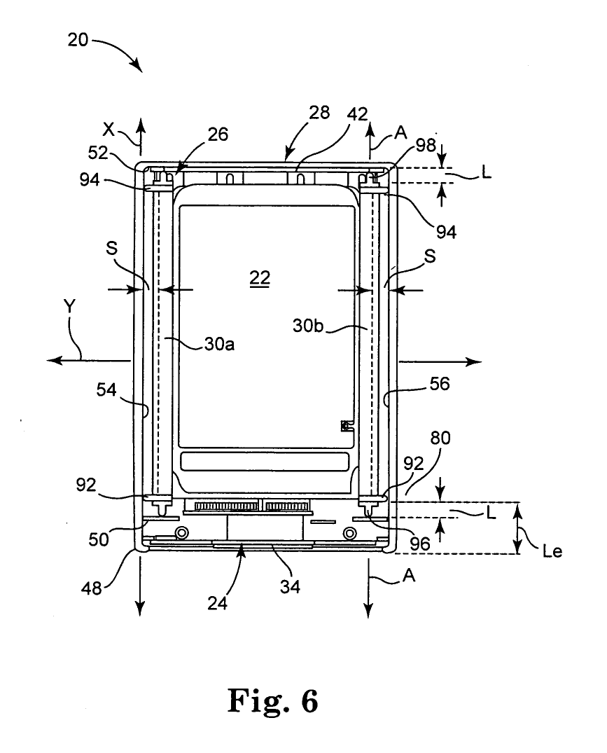

FIG. 6 illustrates a top view of the PHDD 20 having the first housing 40 removed for viewing clarity. The hard drive assembly 22 is retained within the cartridge 26 and isolated from shocks and vibrations by the segments 30a, 30b of shock isolation material. The housing 28 defines a longitudinal axis X that is oriented normal to the ends 50, 52 of the housing 28, and a lateral axis Y that is oriented perpendicularly to the longitudinal axis X. The segments 30a, 30b of shock isolation material are disposed within the housing 28 and oriented parallel to a major axis A. In one embodiment, the major axis A is oriented parallel to the longitudinal axis X.

The hard drive assembly 22 is maintained within the housing 28 and spaced away from the ends 50, 52 and the sides 54, 56 of the enclosure 44 (FIG. 2) by the isolation material 30. In particular, the end rib 96 spaces the hard drive assembly 22 away from the first end 50 by an end sway space L, and the end rib 98 spaces the hard drive assembly 22 away from the second end 52 by an end sway space L. In addition, the isolation material 30 in combination with the first end 50 offsets the hard drive assembly 22 away from the leading end 48 of the housing 28 by a leading end sway space Le. Thus, in one embodiment the leading end sway space Le is greater than the end sway space L. In another embodiment, the leading end sway space Le is greater than the end sway space L by a factor of between about 2-5, and in still another embodiment the leading end sway space Le is about equal to the end sway space L.

The leading end sway space Le defines a deceleration distance for the hard drive assembly 22, at least a part of which includes the rib 96 of the isolation material 30. In one embodiment, the first end 50 is selectively adjusted to enable the end sway space L defined by rib 96 to occupy a majority of the deceleration distance of the leading end sway space Le. In this regard, one embodiment of the present invention provides for the isolation material 30 to occupy a majority of the deceleration distance of the leading end sway space Le.

The ribs 92, 94 space the hard drive assembly 22 away from the sides 54, 56 of the enclosure 44 by a side sway space that is substantially equal to the distance S. In one embodiment, the PHDD 20 is provided with shock absorption that is preferentially greater along the X axis (i.e., longitudinal axis specific shock absorption) in such a manner that the end sway space L is greater than the side sway space S. In a preferred embodiment, the end sway space L is greater than the side sway space S by between about 15-20%, and the leading end sway space Le is greater than the side sway space S by at least a factor of 2, and preferably the leading end sway space Le is greater than the side sway space S by a factor of between about 2-10.

Transportation of the PHDD 20 can lead to dropping and bumping the PHDD 20, which results in imparting a shock force to the hard drive assembly 22. All shocks resulting from drops and bumps that are delivered to the hard drive assembly 22 are potentially deleterious to data stored to, and recoverable from, the hard drive assembly 22. In general, damage due to shock excitation along the lateral axis Y and along a third axis (i.e., a Z axis) that is perpendicularly to both the longitudinal axis X and the lateral axis Y has been determined to be less than the damage due to shock excitation that is delivered to the hard drive assembly 22 along the longitudinal axis X. In other words, the dominant shock excitation failure mode is related to shocks that are delivered to the PHDD 20 along the longitudinal axis X, for example when the PHDD 20 is dropped onto its leading end 48 (or its “nose”).

Embodiments of the present invention provide axis specific shock absorption for the PHDD. In particular, the segments 30 of shock isolation material are oriented along the major axis A and configured such that the end sway space defined by the distance L is maximized relative to the side sway space defined by the distance S. That is to say, shock absorbing material is asymmetrically provided within the enclosure 44 and preferentially aligned along the longitudinal axis X associated with the dominant shock excitation failure mode for the PHDD 20. In one embodiment, the shock absorbing segment 30 is provided continuously along the major axis A (which is parallel to the longitudinal axis X), such that more shock absorbing material is disposed along the longitudinal axis X associated with the dominant shock excitation failure mode for the PHDD 20. In one embodiment, the amount of shock absorbing material is normalized relative to the side sway space S, such that 1 unit width of shock absorbing material has the dimension S. In this regard, it is desired that the shock absorbing material disposed along the longitudinal axis X that is associated with the dominant shock excitation failure mode have more than 1 unit width of shock absorbing material.

In one embodiment, the segments 30 of shock isolation material are configured to provide between about 10-20% more end sway space shock absorption (i.e., the distance L) than side sway space shock absorption (i.e., the distance S), resulting in a combined leading end sway space Le that is about a factor of 2-5 times greater than the side sway space shock absorption S. In this regard, the isolation material 30 is configured to provide sufficient dynamic sideways shock absorption to attenuate and cushion impact forces oriented relative to the lateral axis Y, and a greater amount of dynamic longitudinal shock absorption to attenuate and cushion higher magnitude impact forces oriented along the longitudinal axis X.

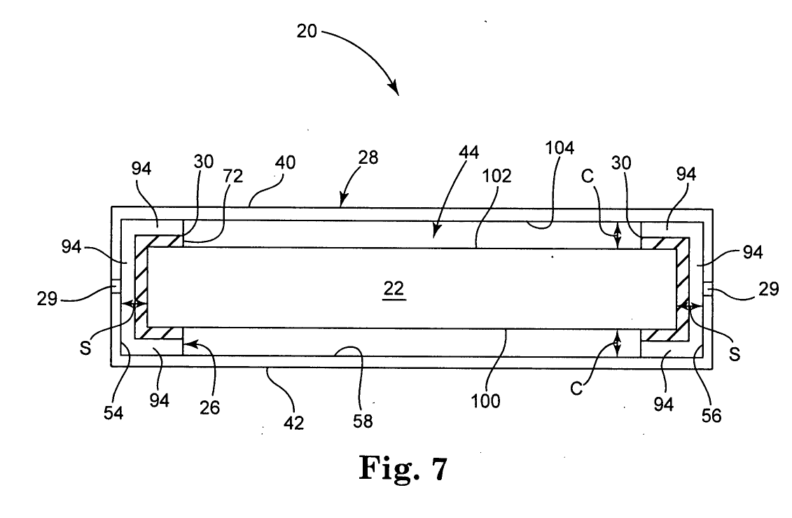

FIG. 7 illustrates a cross-sectional view of the PHDD 20 according to one embodiment of the present invention. The hard drive assembly 22 is retained by the cartridge 26, and in particular, between the shock isolation material 30 and the housing 28. A side of the hard drive assembly 22 is offset from a respective one of the sides 54, 56 of the enclosure 44 by the side sway space S. A first major surface 100 of the hard drive assembly is offset by the clearance space C from the surface 58 of the second housing section 42. In a similar manner, a second major surface 102 of the hard drive assembly 22 is offset by the clearance space C from an inner surface 104 of the first housing section 40. Generally, the side sway space S and the clearance space C are each less than the end sway space L (FIG. 6) and are each less than the leading end sway space Le (FIG. 6). Preferably, the end sway space L is approximately 10-20% greater than either of the end sway space S or the clearance space C, and the leading end sway space Le is at least approximately a factor of 2 greater than either of the end sway space S or the clearance space C.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments of a mobile hard drive provided with axis specific shock absorption as discussed herein. Therefore, it is intended that this invention be limited only by the claims and the equivalents thereof.

What is claimed is:

1. A portable hard disk drive comprising:
a housing forming an enclosure defined by opposing first and second ends, opposing sides extending between the opposing first and second ends, and a top surface opposite a bottom surface;
a hard drive assembly disposed within the enclosure; and
isolation material coupled to the hard drive assembly, the isolation material displacing the hard drive assembly from the opposing first and second ends by an end sway space and displacing the hard drive assembly from each of the opposing sides by a side sway space;
wherein the end sway space is greater than the side sway space.

2. The portable hard disk drive of claim 1, wherein the housing defines a leading end separate from the first end, and further wherein the isolation material displaces the hard drive assembly from the leading end of the housing by a leading end sway space that is between about a factor of 2-4 times larger than the side sway space.

3. The portable hard disk drive of claim 2, wherein the leading end sway space is larger than the end sway space.

4. The portable hard disk drive of claim 1, wherein the housing defines a longitudinal axis oriented normal to the first and second ends of the enclosure, the longitudinal axis associated with a dominant shock failure mode characterized by crashing a head of the hard drive assembly into disks of the hard drive assembly, and further wherein a major axis of the isolation material is oriented parallel to the longitudinal axis.

5. The portable hard disk drive of claim 4, wherein the isolation material extends continuously along the major axis between the first and second ends of the enclosure.

6. The portable hard disk drive of claim 4, wherein the housing defines a lateral axis oriented normal to the opposing sides of the enclosure, and further wherein the isolation material is configured to provide greater shock absorption along the longitudinal axis than along the lateral axis.

7. The portable hard disk drive of claim 1, wherein the isolation material is a shock absorbing material comprising:
a first molded segment coupled to a first side of the hard drive assembly; and
a separate second molded segment coupled to a second side of the hard drive assembly opposite of the first side of the hard drive assembly.

8. The portable hard disk drive of claim 7, wherein each of the first and second molded segments comprise opposing end ribs, the end ribs sized to displace the hard drive assembly from the opposing first and second ends of the enclosure by the end sway space.

9. A method of providing axis specific shock absorption for a portable hard disk drive, the method comprising:
forming a housing that defines an enclosure;
disposing a hard drive assembly within the enclosure to define:
a longitudinal space between a leading end of the hard drive assembly and a first end of the enclosure,
a lateral space between a side of the hard drive assembly and a side of the enclosure,
a clearance space between a major surface of the hard drive assembly and an interior surface of the enclosure; and
distributing shock absorbing material unequally between the longitudinal, lateral, and clearance spaces.

10. The method of claim 9, wherein the longitudinal space is greater than each of the lateral and clearance spaces.

11. The method of claim 9, wherein disposing a hard drive assembly within the enclosure comprises not centering the hard drive assembly within the enclosure such that the longitudinal space is greater than each of the lateral and clearance spaces by about a factor of two.

12. The method of claim 9, wherein the lateral space is normalized to define one unit width, and further wherein distributing shock absorbing material unequally between the longitudinal, lateral, and clearance spaces comprises distributing more than one unit width of shock absorbing material in the longitudinal space.

13. The method of claim 9, wherein the housing defines a longitudinal axis and a lateral axis perpendicular to the longitudinal axis, the longitudinal axis associated with a dominant shock failure mode of the removable hard disk drive, and further wherein distributing shock absorbing material unequally comprises maximizing an amount of shock absorbing material that is disposed along the longitudinal axis.

14. The method of claim 9, wherein the enclosure defines a second end opposite the first end, the shock absorbing material extending continuously between the first and second ends of the enclosure.

15. A cartridge configured to portably maintain a hard drive assembly, the cartridge comprising:
a housing defining an enclosure including opposing first and second ends, opposing sides extending between the opposing first and second ends, and a top surface opposite a bottom surface; and
shock isolation material disposed within the enclosure, the shock isolation material including a first segment coupleable to a first portion of the hard drive assembly to extend between the opposing first and second ends of the enclosure, and a second segment coupleable to a second portion of the hard drive assembly to extend between the opposing first and second ends of the enclosure;
wherein when the first and second segments of the shock isolation material are coupled to the hard drive assembly, the hard drive assembly is spaced a distance from the ends of the enclosure that is greater than a distance that the hard drive assembly is spaced from the sides of the enclosure.

16. The cartridge of claim 15, wherein each of the first and second segments of the shock isolation material include a body that defines a first face and an opposing second face, the first face defining a recessed cavity sized to receive a side of the hard drive assembly and the second face including at least one rib projecting from the second face.

17. The cartridge of claim 16, wherein the body is substantially rectangular in cross-section and includes a third face opposite a fourth face, each of the third and fourth faces including at least one rib projecting respectively therefrom.

18. The cartridge of claim 17, wherein the body defines at least one continuous rib projecting a uniform distance off of each of the second, third, and fourth faces.

19. The cartridge of claim 18, wherein the body defines a first end opposite a second end, the first end including a first end rib projecting therefrom and the second end including a second end rib projecting therefrom.

20. The cartridge of claim 18, wherein the body defines first and second continuous ribs, the first continuous rib formed adjacent to the first end and projecting a uniform distance off of each of the second, third, and fourth faces, and the second continuous rib formed adjacent to the second end and projecting a uniform distance off of each of the second, third, and fourth faces.
